(19) United States
(12) Patent Application Publication
(10) Pub. No.: US 2020/0019523 A1
(43) Pub. Date: Jan. 16, 2020

(54) DELAYED BANK SWITCH COMMANDS IN AN AUDIO SYSTEM

(71) Applicant: QUALCOMM Incorporated, San Diego, CA (US)

(72) Inventors: Lior Amarilio, Yokneam (IL); Sharon Graif, Zichron Yaakov (IL); Yiftach Benjamini, Givat Ela (IL)

(21) Appl. No.: 16/032,238

(22) Filed: Jul. 11, 2018

(51) Int. Cl. G06F 13/362; G06F 3/16; G06F 13/40

(52) U.S. Cl. CPC G06F 13/362; G06F 13/4022; G06F 3/165

(57) ABSTRACT

Delayed bank switch commands in an audio system such as a SOUNDWIRE audio system may have slaves that have had a delay register added to register banks for each data port. When a bank switch command is received, a slave consults the delay register and delays switching by a number of frames indicated in the delay register. Such delays may be used to prevent interpreting non-audio data as part of a data stream, particularly at start up and closure of audio streams. If an audio stream is active, the delay may be set to zero. By precluding the evaluation of non-audio data, audio artifacts may be avoided and a better user experience provided.

### BACKGROUND

### I. Field of the Disclosure

The technology of the disclosure relates generally to audio buses and activation of devices on audio buses.

### II. Background

Mobile communication devices have become increasingly common in current society. The prevalence of these mobile communication devices is driven in part by the many functions that are now enabled on such devices. Increased processing capabilities in such devices means that mobile communication devices have evolved from pure communication tools into sophisticated mobile entertainment centers, thus enabling enhanced user experiences.

The mobile communication devices commonly include at least one microphone and multiple speakers. The microphone and the speakers used in the mobile communication devices typically have analog interfaces which require a dedicated two-wire connection between each pair of devices. Since a mobile communication device is capable of supporting multiple audio devices, it may be desired to allow a microprocessor or other control device in the mobile communication device to communicate audio data to multiple audio devices over a common communication bus simultaneously.

In this regard, the MIPI® Alliance has developed SoundWire℠ (SOUNDWIRE), a communication protocol for a processor in the mobile communication device (the “master”) to control distribution of digital audio streams between one or more audio devices (the “slave(s)”) via one or more SOUNDWIRE slave data ports. The SOUNDWIRE specification, both versions 1.0 and 1.1 released January 2015 and August 2016, respectively, uses banks of registers to store operating parameters. There are typically two such banks—one active and one passive. The master updates the entries in the passive bank to provide operating parameters for a future operation and then uses a bank switch command to cause the operation to change to the next set of operating parameters.

Both versions of SOUNDWIRE contemplate that the master will issue a bank switch command, and that ALL the slaves will switch operation between banks of registers at the same time within the frame. While this simultaneous switching is helpful during active operations to minimize disruption of audio streams, there may be occasions, such as during start up or shut down of an audio stream, where it may be advantageous to enable or disable audio sources and audio sinks at different times to allow for the devices to begin operation sequentially.

### SUMMARY OF THE DISCLOSURE

Aspects disclosed in the detailed description include delayed bank switch commands in an audio system. In an exemplary aspect, the audio system is a SOUNDWIRE audio system in which slaves have had a delay register added to register banks for each data port. When a bank switch command is received, a slave consults the delay register and delays switching by a number of frames indicated in the delay register. Such delays may be used to prevent interpreting non-audio data as part of a data stream, particularly at start up and closure of audio streams. If an audio stream is active, the delay may be set to zero. By precluding the evaluation of non-audio data, audio artifacts may be avoided and a better user experience provided.

In this regard in one aspect, a method for controlling devices on an audio bus is disclosed. The method includes receiving, at a slave device on an audio bus, a command from a master on the audio bus to change an operation of a data port at a specific time relative to the command The method also includes retrieving a delay value for the data port from a delay register within the slave device. The method also includes changing the operation of the data port of the slave device after the specific time based on the delay value.

In another aspect, a device associated with an audio bus is disclosed. The device includes a bus interface configured to couple to an audio bus. The device also includes a data port delay register configured to hold a delay value. The device also includes a control system. The control system is configured to receive a command from a master on the audio bus to change an operation of a data port of the device at a specific time relative to the command. The control system is also configured to retrieve the delay value from the data port delay register. The control system is also configured to change the operation of the data port of the device after the specific time based on the delay value.

In another aspect, an audio system is disclosed. The audio system includes a master. The audio system also includes an audio bus coupled to the master. The audio system also includes an audio source including a first data port delay register containing a first data port delay value. The audio source is coupled to the audio bus. The audio system also includes an audio sink including a second data port delay register containing a second data port delay value larger than the first data port delay value. The audio sink is coupled to the audio bus. The master is configured to send a command to change an operation at a specific time. The audio source delays changing the operation based on the first data port delay value relative to the specific time. The audio sink delays changing the operation based on the second data port delay value relative to the specific time.

### BRIEF DESCRIPTION OF THE FIGURES

FIG. 1 is a schematic diagram of an exemplary conventional MIPI® Alliance SoundWire℠ (SOUNDWIRE) system topology according to the MIPI® Alliance SOUNDWIRE specification version 1.0 published Jan. 21, 2015;

FIG. 2 is a schematic diagram of an exemplary conventional structure of a SOUNDWIRE slave device;

FIG. 3 is a flowchart illustrating a conventional bank switch process for the SOUNDWIRE system of FIG. 1;

FIG. 4 is a schematic diagram of an exemplary SOUNDWIRE slave device with a delay register added according to aspects of the present disclosure;

FIG. 5 is a simplified timeline showing sequential activation and sequential deactivation of devices on a SOUNDWIRE bus;

FIG. 6 is a flowchart illustrating a bank switch process with delay options according to exemplary aspects of the present disclosure;

FIG. 7 is a time diagram showing delayed bank switching relative to a fixed point during activation of an audio stream;

FIG. 8 is a time diagram showing delayed bank switching relative to a fixed point during deactivation of an audio stream; and

FIG. 9 is a block diagram of an exemplary processor-based system that can include the slave device with a delay register of FIG. 4.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include delayed bank switch commands in an audio system. In an exemplary aspect, the audio system is a SOUNDWIRE audio system in which slaves have had a delay register added to register banks for each data port. When a bank switch command is received, a slave consults the delay register and delays switching by a number of frames indicated in the delay register. Such delays may be used to prevent interpreting non-audio data as part of a data stream, particularly at start up and closure of audio streams. If an audio stream is active, the delay may be set to zero. By precluding the evaluation of non-audio data, audio artifacts may be avoided and a better user experience provided.

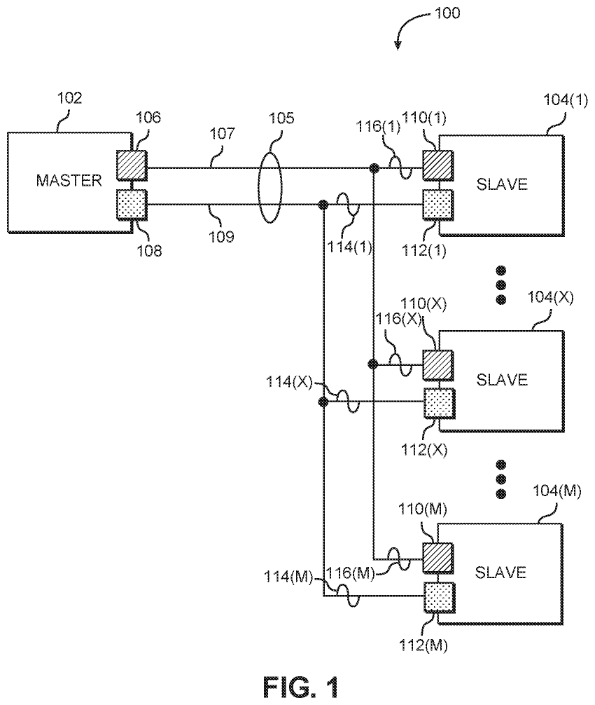

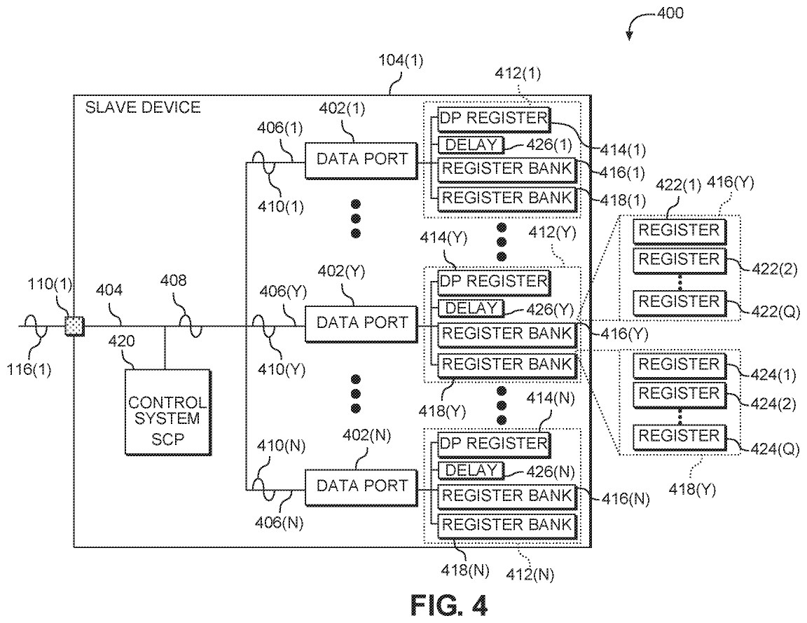

Before discussing exemplary aspects of delayed bank switch commands that include specific aspects of the present disclosure, a brief overview of register bank operation and related aspects, performed by a conventional SOUNDWIRE data port are first provided with reference to FIGS. 1-3. The discussion of specific exemplary aspects of the delayed bank switch commands starts below with reference to FIG. 4.

In this regard, FIG. 1 is a schematic diagram of an exemplary SOUNDWIRE system 100 according to the MIPI® Alliance SOUNDWIRE specification version 1.0 published Jan. 21, 2015 and/or the SOUNDWIRE specification version 1.1 published August 2016, both of which are incorporated herein by reference. The SOUNDWIRE system 100 comprises a master device 102 and a plurality of slave devices 104(1)-104(M) communicatively coupled by a SOUNDWIRE bus 105. The master device 102 may support up to eleven (11) slave devices. However, it may be possible for the master device 102 to support more than 11 slave devices in future SOUNDWIRE specifications. The master device 102 provides a data interface 106 configured to couple to a data line 107 in the SOUNDWIRE bus 105 and a clock interface 108 configured to couple to a clock line 109 in the SOUNDWIRE bus 105. The plurality of slave devices 104(1)-104(M) comprises a plurality of respective slave data interfaces 110(1)-110(M) configured to couple to the data line 107 and a plurality of respective slave clock interfaces 112(1)-112(M) configured to couple to the clock line 109.

The master device 102 may provide a plurality of respective clock signals 114(1)-114(M) from the clock interface 108 to the plurality of slave clock interfaces 112(1)-112(M) through the clock line 109. The master device 102 also communicates a plurality of respective data signals 116(1)-116(M) between the data interface 106 and the plurality of slave data interfaces 110(1)-110(M) through the data line 107. Each of the plurality of data signals 116(1)-116(M) comprises control information and multiplexed payload streams associated with a respective slave device among the plurality of slave devices 104(1)-104(M). SOUNDWIRE provides a time division multiplexed (TDM) arrangement where the plurality of slave devices 104(1)-104(M) may place data on the data line 107 in designated slots within the frame. For example, slave device 104(X) may be an audio sink that receives audio data from the slave device 104(1) through the data line 107.

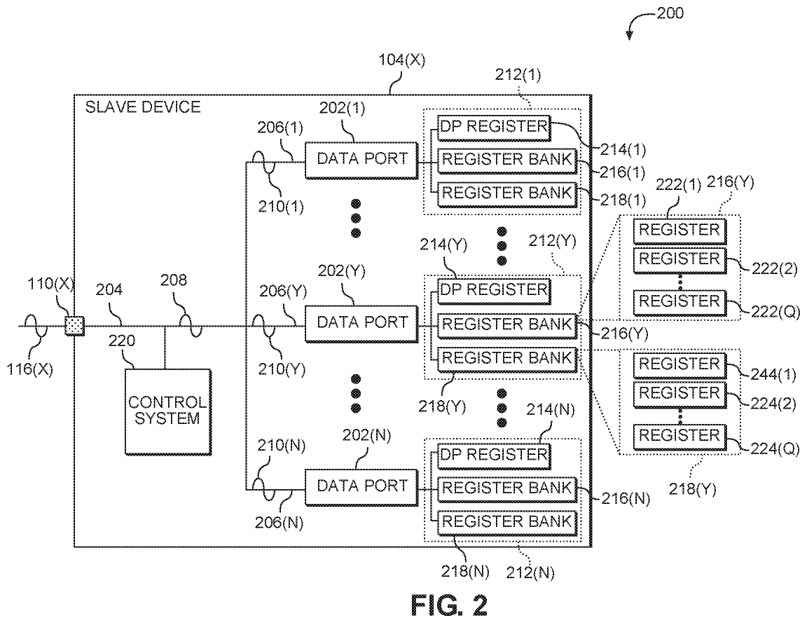

To further illustrate inner structures of the plurality of slave devices 104(1)-104(M), the slave device 104(X) is discussed as a non-limiting example. In this regard, FIG. 2 is a schematic diagram of an exemplary conventional structure 200 of the slave device 104(X).

With reference to FIG. 2, data signal 116(X) received via slave data interface 110(X) is provided to a plurality of data ports 202(1)-202(N) via an internal bus 204. The plurality of data ports 202(1)-202(N) corresponds to a plurality of respective SOUNDWIRE channels 206(1)-206(N). In a non-limiting example, the plurality of SOUNDWIRE channels 206(1)-206(N) may be audio channels. The data signal 116(X) is de-multiplexed to generate a control signal 208 and a plurality of respective SOUNDWIRE payload streams 210(1)-210(N) that corresponds to the plurality of data ports 202(1)-202(N). In this regard, the plurality of data ports 202(1)-202(N) may be a sink of the plurality of SOUNDWIRE payload streams 210(1)-210(N).

With continuing reference to FIG. 2, the plurality of data ports 202(1)-202(N) is controlled by a plurality of respective register sets 212(1)-212(N). In a non-limiting example, according to the SOUNDWIRE specification, each of the plurality of register sets 212(1)-212(N) has a register address space of 256 bytes. The plurality of register sets 212(1)-212(N) is divided into a plurality of respective data port (DP) registers 214(1)-214(N) (sometimes referred to as Non-Banked Registers), a plurality of respective first register banks 216(1)-216(N), and a plurality of respective second register banks 218(1)-218(N). For the convenience of reference and illustration, data port 202(Y) is discussed herein as a non-limiting example.

With continuing reference to FIG. 2, register set 212(Y) controls payload transports to the data port 202(Y). Specifically, DP register 214(Y) contains static configurations of the data port 202(Y) that are typically unchanged while the data port 202(Y) is receiving SOUNDWIRE payload stream 210(Y). In contrast, dynamic configurations of the data port 202(Y), which may be changed while receiving the SOUNDWIRE payload stream 210(Y), are duplicated in first register bank 216(Y) and second register bank 218(Y) to facilitate seamless operational changes in the data port 202(Y). In this regard, at any given time, one register bank (e.g., the first register bank 216(Y)), is selected by a control system 220 of the slave control port (SCP) to function as an active register bank to control operations (present operation) of the data port 202(Y) while the other register bank (e.g., the second register bank 218(Y)), serves as a passive register bank and stays offline. The first register bank 216(Y) and the second register bank 218(Y) of the data port 202(Y) comprise a plurality of first registers 222(1)-222(Q) and a plurality of second registers 224(1)-224(Q), respectively.

When the master device 102 of FIG. 1 needs to reconfigure the data port 202(Y) for a future operation that is different from the present operation of the data port 202(Y), the control system 220 duplicates the dynamic configurations of the data port 202(Y) from the active register bank (the first register bank 216(Y)) to the passive register bank (the second register bank 218(Y)) and then makes necessary updates in the passive register bank. This is an effective approach to update the dynamic configurations of the data port 202(Y), especially when the data port 202(Y) continues receiving the SOUNDWIRE payload stream 210(Y). Once the updates in the passive register bank are completed, the control system 220 inverts the passive register bank and the active register bank to bring the passive register bank, which contains the updated dynamic configurations of the data port 202(Y), online to control the future operation of the data port 202(Y). As a result, the second register bank 218(Y) becomes the active register bank and the first register bank 216(Y) becomes the passive register bank and stays offline. The inversion of active and passive banks is accomplished through a bank switch command from the master device 102. The SOUNDWIRE specification requires that the inversion occur simultaneously for all ports.

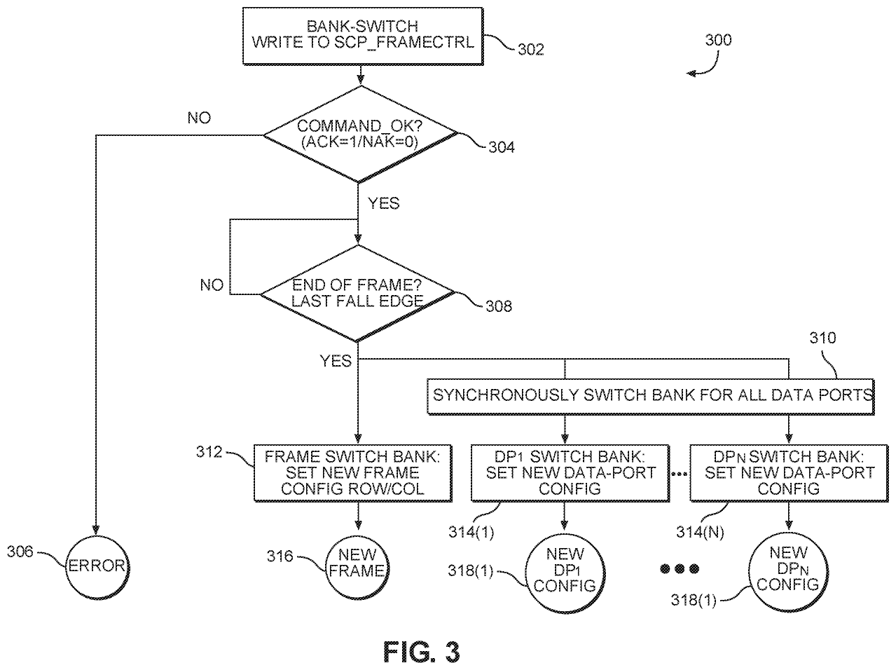

FIG. 3 provides a flowchart of a process 300 corresponding to the simultaneous bank switch. In particular, the process 300 begins with a bank switch command being written to the SCP of the control system 220, and in particular, the bank switch command is written to a SCP_FrameCtrl register (not illustrated) (block 302). The control system 220 verifies that the command is valid through an acknowledgment/not acknowledged (ACK/NACK) signal (block 304). If the command is not valid, then an error is generated (block 306). If the command is valid, then the process 300 waits to an end of a frame, and particularly, a last falling edge of the frame (block 308). When the last falling edge of the frame is reached, the data ports 202(1)-202(N) all switch banks synchronously (block 310), and the control system 220 sets a new frame configuration (block 312) while the data ports 202(1)-202(N) set a new data port configuration (blocks 314(1)-314(N)). A new frame arrives (block 316) and the data ports 202(1)-202(N) process it using the new data port configuration (blocks 318(1)-318(N)).

Exemplary aspects of the present disclosure allow the data ports to be sequentially activated through a bank switch command such that the switch actually takes place after a predefined delay time rather than concurrently with the bank switch command. Such sequential activation may be appropriate at start up to prevent an audio sink from reading data from the bus before data is placed thereon by the audio source. Likewise, such approach may be appropriate at the end of an audio stream, again to prevent the audio sink from treating bits on the bus as audio data when, in fact, those bits are merely noise. Preventing the audio sink from reading these bits will improve the end user's audio experience.

In this regard, FIG. 4 is a schematic diagram of a structure 400 of a slave device 104(1) according to exemplary aspects of the present disclosure. A data signal 116(1) received via slave data interface 110(1) is provided to a plurality of data ports 402(1)-402(N) via an internal bus 404. The plurality of data ports 402(1)-402(N) corresponds to a plurality of respective SOUNDWIRE channels 406(1)-406(N). In a non-limiting example, the plurality of SOUNDWIRE channels 406(1)-406(N) may be audio channels. The data signal 116(1) is de-multiplexed to generate a control signal 408 and a plurality of respective SOUNDWIRE payload streams 410(1)-410(N) that corresponds to the plurality of data ports 402(1)-402(N). In this regard, the plurality of data ports 402(1)-402(N) may be a sink of the plurality of SOUNDWIRE payload streams 410(1)-410(N).

With continuing reference to FIG. 4, the plurality of data ports 402(1)-402(N) is controlled by a plurality of respective register sets 412(1)-412(N). In a non-limiting example, according to the SOUNDWIRE specification, each of the plurality of register sets 412(1)-412(N) has a register space that is 256 bytes. The plurality of register sets 412(1)-412(N) is divided into a plurality of respective DP registers 414(1)-414(N) (sometimes referred to as Non-Banked Registers), a plurality of respective first register banks 416(1)-416(N), and a plurality of respective second register banks 418(1)-418(N). For the convenience of reference and illustration, data port 402(Y) is discussed herein as a non-limiting example. First register bank 416(Y) and second register bank 418(Y) of the data port 402(Y) comprise a plurality of first registers 222(1)-222(Q) and a plurality of second registers 224(1)-224(Q), respectively.

While the above description is similar to the description for the structure 200 of FIG. 2, exemplary aspects of the present disclosure add delay registers 426(1)-426(N) to the respective register sets 412(1)-412(N). The delay registers 426(1)-426(N) indicate how many frames after a fixed point, such as a stream synchronization point (SSP), each of the data ports 402(1)-402(N) is to activate so as to send or receive data. It is this ability to delay activation for different elements on the bus by differing amounts that, for example, prevents an audio sink from improperly treating non-data (that may be on a bus before an audio source places data on the bus) as data to be processed and output to a user (e.g., played through a speaker). By ignoring such non-data, no spurious audio artifacts are presented to an end user, and the user experience is improved.

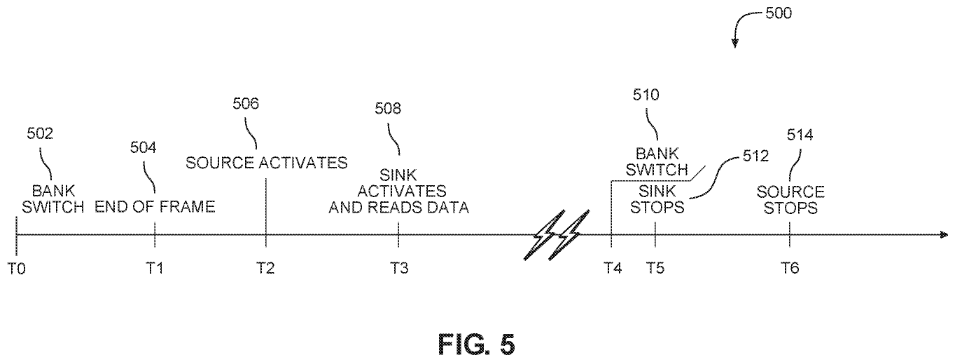

Before providing a flowchart for a process to use the delay registers 426(1)-426(N), a simplified timeline 500 is provided in FIG. 5 to illustrate how staggered activation works relative to an audio stream. In this regard, at time T0, a master issues a bank switch command 502. In a conventional system, ALL devices would switch at an end of a frame 504 (time T1) in which the bank switch command was issued and received correctly (i.e., no PARITY error, no operation is required as is well understood). Exemplary aspects of the present disclosure allow sequential, staggered switching/activation based on values in the delay registers 426(1)-426(N). Thus, at time T2, some number of frames after time T1, an audio source activates 506. Prior to the activation 506, the audio source does not put any data on the bus, but after the activation 506, the audio source begins placing audio data on the bus. At time T3, some number of frames after time T2, an audio sink activates 508. At the activation 508, the audio sink is able to read the data that the audio source has put on the bus. In this manner, the audio sink does not read spurious data on the bus and thus, the audio sink does not improperly treat such spurious data as audio data. Preventing such improper activity reduces the likelihood of an audio artifact being played to the end user and improves the user experience.

Similarly, at an end of an audio stream, there may be sequential, staggered deactivation of the devices. Thus, at time T4, a bank switch command is issued 510, and the audio sink stops at an end of a frame 512 (time T5). When the audio sink stops, the audio sink no longer reads data from the bus and thus cannot receive any spurious data for improper playback to the end user. At some subsequent time T6, after a number of frames indicated in the respective delay register 426(1)-426(N), the audio source stops putting data on the bus 514.

While starting and stopping periods of audio streams may benefit from the present disclosure, it should be appreciated that other activity may likewise benefit from such sequential, staggered switching delays. Likewise, the delay in the delay register may be set to zero for bank switches that occur in mid-audio stream so that there are no inadvertent artifacts introduced into the audio stream.

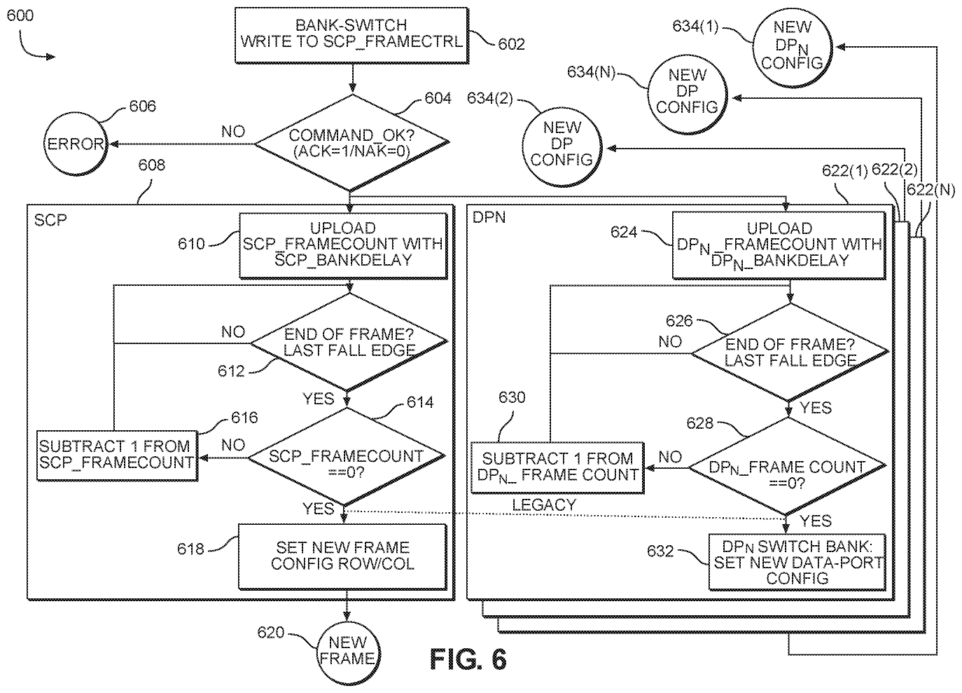

A process 600 for executing delayed bank switch commands in an audio system is provided with reference to FIG. 6. Before the process 600 begins, the host will write a value to appropriate ones of the delay registers 426(1)-426(N). The value may be selected from a look-up table, from empirical results, or the like. The values do not have to be uniform for different ones of the delay registers 426(1)-426(N). It should be appreciated that if the value is 0x00, then no delay will be implemented. Likewise, if the delay registers 426(1)-426(N) are not present (i.e., a legacy situation), then no delay will be implemented. The process 600 begins with a bank switch command being written to the SCP of the control system 420, and in particular, the bank switch command is written to a SCP_FrameCtrl register (not illustrated) (block 602). The control system 420 verifies that the command is valid through an ACK/NACK signal (block 604). If the command is not valid, then an error is generated (block 606). If the command is valid, then the process 600 bifurcates based on the location. A first branch 608 occurs in the SCP. The process 600 continues by uploading a SCP_FrameCount with a SCP_BankDelay (block 610), where the SCP_BankDelay is retrieved from one of the delay registers 426(1)-426(N). The control system 420 tests to see if the last falling edge of the end of the frame has occurred (block 612). If the answer is no, the process 600 repeats until a yes occurs. The control system 420 then tests to see if the SCP_FrameCount is zero (block 614). If the answer is no, then the control system decrements the SCP_FrameCount by one (block 616) and the process 600 returns to block 612. If, however, the answer to block 614 is yes, the SCP_FrameCount has been decremented to zero (or was set to zero initially), then the control system 420 sets a new frame configuration using a new row/column (block 618) and a new frame arrives (block 620). Thus, the SCP uses the value in the delay register to delay switching banks by a number of frames equal to the value in the delay register.

A second branch operates at each of the data ports 402(1)-402(N), and thus, second branches 622(1)-622(N) are identical. The second branch begins by uploading a DP_FrameCount with a DP_BankDelay (block 624), where the DP_BankDelay is retrieved from the respective delay register 426(1)-426(N). The respective data port 402(1)-402(N) tests to see if the last falling edge of the end of the frame has occurred (block 626). If the answer is no, the process 600 repeats until a yes occurs. The respective data port 402(1)-402(N) tests to see if the DP_FrameCount is zero (block 628). If the answer is no, then the control system 420 decrements the DP_FrameCount by one (block 630), and the process 600 returns to block 626. If, however, the answer to block 628 is yes, the DP_FrameCount has been decremented to zero, then the control system 420 sets a new data port configuration (block 632), and the new data port configuration begins being used at the end of the frame as indicated by the falling edge (blocks 634(1)-634(N)). Thus, the respective data port 402(1)-402(N) uses the value in the respective delay register 426(1)-426(N) to delay switching banks by a number of frames equal to the value in the delay register.

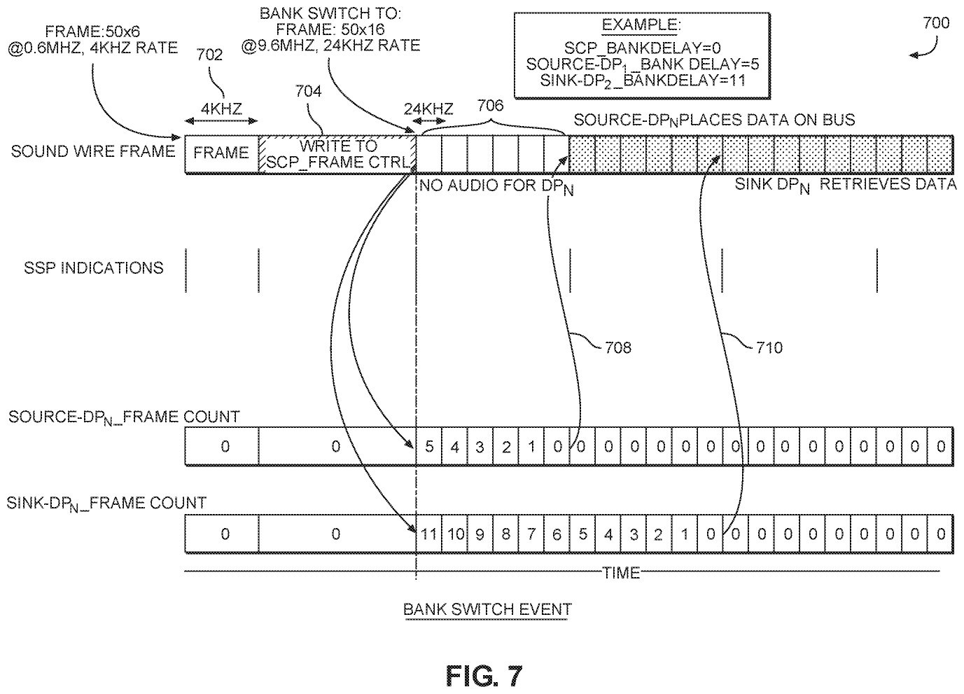

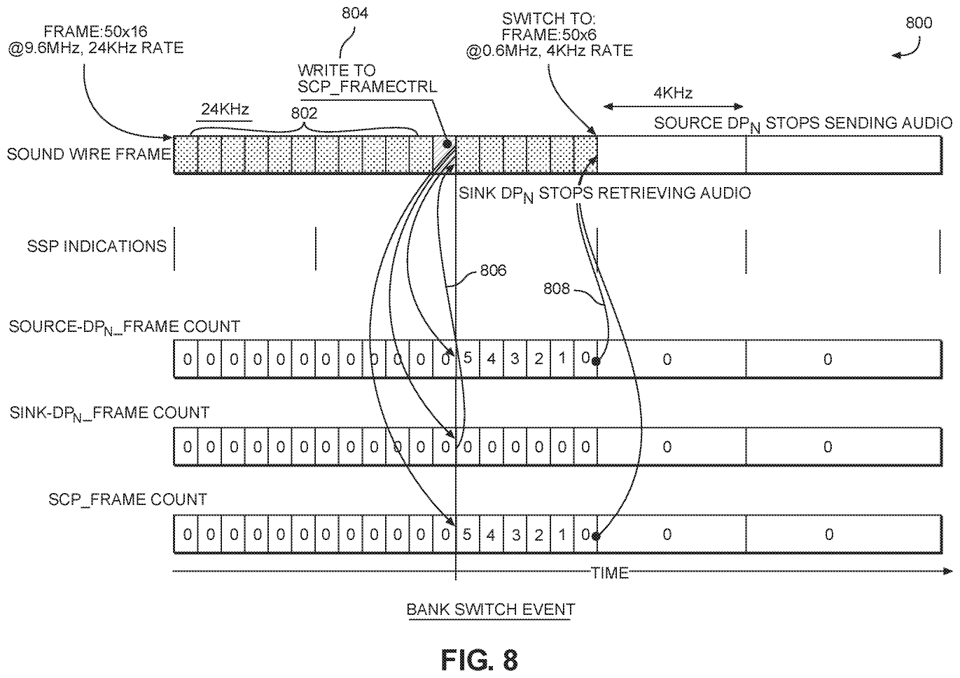

A more detailed example of the timeline of FIG. 5, with individual frames counted is provided in FIGS. 7 and 8. In this regard, FIG. 7 illustrates a time diagram 700 for activating audio. In this regard, the time diagram 700 shows that there is an initial frame size of 50×6 at a clock frequency of 0.6 megahertz (MHz) corresponding an frame rate of four kilohertz (4 kHz) shown generally at 702. Note that at some point during operation at the initial frame size, the software may update the desired values in the non-active bank register for all data ports and may specifically write a specific value into the delay registers 426(1)-426(N). For the sake of this example, the SCP_BankDelay is zero, the DP1_BankDelay is five, and the DP2_BankDelay is eleven. The master writes to the SCP_FrameCtrl indicating a bank switch shown generally at 704. At the end of the frame, at a fixed point in time (i.e., the SSP), the frame switches to the new size of 50×16 at a clock frequency of 9.6 MHz, corresponding to a 24 kHz frame rate. The audio sink (DP2) and the audio source (DP1) load their delay values into the DP_FrameCount (e.g., eleven (11) and five (5), respectively). Initially, since the audio source is not active, there is no audio data on the bus (shown generally at 706), but after six frames, the audio source activates and places audio data on the bus (shown generally at 708). The audio sink is still decrementing its DP_FrameCount and thus is not reading the data on the bus until the end of the twelfth frame, at which time the audio sink begins to retrieve data (shown generally at 710). Again, by delaying the audio sink activation until after the audio source has put data on the bus, the audio sink does not treat spurious data as part of the audio stream, and fewer audio artifacts are created, thereby improving the listener experience.

Similarly, FIG. 8 illustrates a time diagram 800 for disabling audio. In this regard, the time diagram 800 shows that there is an initial frame size of 50×16 at a clock frequency of 9.6 MHz corresponding an frame rate of 24 kHz shown generally at 802. Note that at some point during operation at the initial frame size, the software may update the desired values in the non-active bank register for all data ports and may specifically write a specific value into the delay registers 426(1)-426(N). For the sake of this example, the SCP_BankDelay is zero, the DP1_BankDelay is five, and the DP2_BankDelay is five. The master writes to the SCP_FrameCtrl indicating a bank switch shown generally at 804. At the end of the frame, at a fixed point in time (i.e., the SSP), sometimes referred to as a specific time, the frame switches to the new size of 50×6 at a clock frequency of 0.6 MHz, corresponding to a 4 kHz rate. The audio sink and the audio source load their delay values into the DP_FrameCount (e.g., zero (0) and six (6), respectively). At the bank switch, the audio sink immediately discontinues reception of audio data since its delay value was zero (shown generally at 806). The audio source continues to send audio data for six more frames and then stops when its DP_FrameCount equals zero (shown generally at 808). Again, by disabling the audio sink prior to disabling the audio source, the audio sink does not treat spurious data as part of the audio stream, and fewer audio artifacts are created, thereby improving the listener experience.

While the above disclosure focuses on SOUNDWIRE, it should be appreciated that aspects of the present disclosure may be adapted to other audio buses such as SLIMBUS or the like.

The delayed bank switch commands in an audio system according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

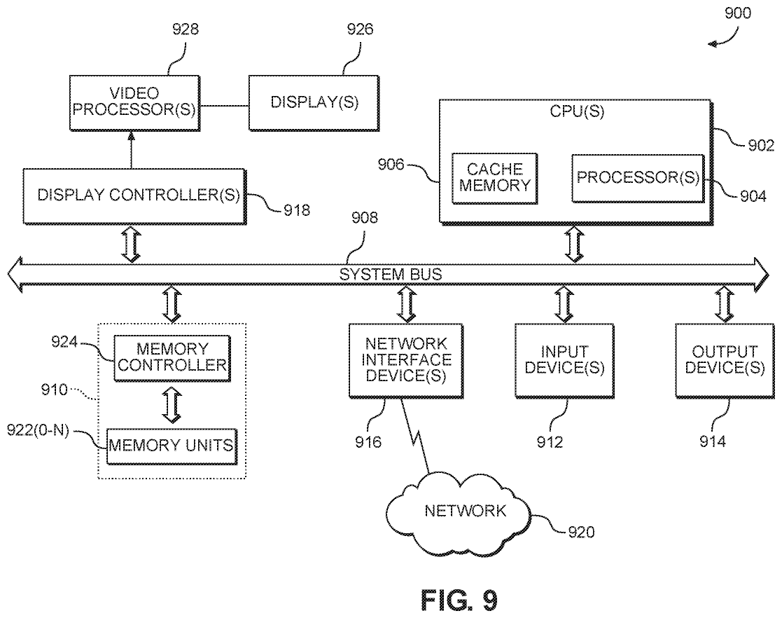

In this regard, FIG. 9 illustrates an example of a processor-based system 900 that can employ the delay registers 426(1)-426(N) for slave devices in a SOUNDWIRE system as illustrated in FIG. 4. In this example, the processor-based system 900 includes one or more central processing units (CPUs) 902, each including one or more processors 904. The CPU(s) 902 may have cache memory 906 coupled to the processor(s) 904 for rapid access to temporarily stored data. The CPU(s) 902 is coupled to a system bus 908 and can intercouple master and slave devices included in the processor-based system 900. As is well known, the CPU(s) 902 communicates with these other devices by exchanging address, control, and data information over the system bus 908. Although not illustrated in FIG. 9, multiple system buses # could be provided, wherein each system bus 908 constitutes a different fabric.

Other master and slave devices can be connected to the system bus 908. As illustrated in FIG. 9, these devices can include a memory system 910#, one or more input devices #912 one or more output devices 914, one or more network interface devices 916, and one or more display controllers 918, as examples. The input device(s) 912 can include any type of input device, including, but not limited to, input keys, switches, voice processors, etc. The output device(s) 914 can include any type of output device, including, but not limited to, audio, video, other visual indicators, etc. The network interface device(s) 916 can be any devices configured to allow exchange of data to and from a network 920. The network 920 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 916 can be configured to support any type of communications protocol desired. The memory system 910 can include one or more memory units 922(0-N) and a memory controller 924.

The CPU(s) 902 may also be configured to access the display controller(s) 918 over the system bus 908 to control information sent to one or more displays 926. The display controller(s) 918 sends information to the display(s) 926 to be displayed via one or more video processors 928, which process the information to be displayed into a format suitable for the display(s) 926. The display(s) 926 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

1. A method for controlling devices on an audio bus, comprising:
receiving, at a slave device on the audio bus, a command from a master on the audio bus to change an operation of a data port at a specific time relative to the command;
retrieving a delay value for the data port from a delay register within the slave device; and
changing the operation of the data port of the slave device after the specific time based on the delay value.

2. The method of claim 1, further comprising storing the delay value for the data port in the delay register of the slave device.

3. The method of claim 2, wherein storing the delay value comprises receiving the delay value for the data port from the master.

4. The method of claim 1, wherein the command comprises a bank switch command.

5. The method of claim 4, wherein the specific time comprises an end of frame for a frame containing the bank switch command.

6. The method of claim 5, wherein the delay value for the data port represents a number of frames after the end of frame for the frame containing the bank switch command.

7. The method of claim 1, wherein the command comprises a command to activate an audio stream.

8. The method of claim 7, wherein the slave device comprises an audio sink and the delay value for the data port is set so that an audio source on the audio bus begins sending audio data before the data port of the slave device begins processing the audio stream.

9. The method of claim 1, wherein the command comprises a command to disable an audio stream.

10. The method of claim 1, further comprising setting a frame count at the delay value for the data port and decrementing the frame count until zero before changing the operation of the data port.

11. The method of claim 1, wherein receiving, at the slave device on the audio bus comprises receiving at the slave device on a SOUNDWIRE version 1.1 released August 2016 audio bus.

12. A device associated with an audio bus, the device comprising:
a bus interface configured to couple to the audio bus;
a data port delay register configured to hold a delay value; and
a control system configured to:
receive a command from a master on the audio bus to change an operation of a data port of the device at a specific time relative to the command;
retrieve the delay value from the data port delay register; and
change the operation of the data port of the device after the specific time based on the delay value.

13. The device of claim 12, wherein the device comprises an audio source.

14. The device of claim 12, wherein the device comprises an audio sink.

15. The device of claim 12, wherein the device comprises a slave device configured to be coupled to a SOUNDWIRE version 1.1, released August 2016 bus.

16. The device of claim 12, wherein the command comprises a bank switch command.

17. The device of claim 16, wherein the specific time comprises an end of frame for a frame containing the bank switch command.

18. The device of claim 17, wherein the delay value represents a number of frames after the end of frame for the frame containing the bank switch command.

19. The device of claim 12, wherein the command comprises a command to activate an audio stream.

20. The device of claim 19, wherein the device comprises an audio sink and the delay value is set so that an audio source on the audio bus begins sending audio data before the device begins processing the audio stream.

21. The device of claim 12, wherein the command comprises a command to disable an audio stream.

22. The device of claim 12 integrated into an integrated circuit (IC).

23. The device of claim 12 integrated into an apparatus selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

24. An audio system comprising:
a master;
an audio bus coupled to the master;
an audio source comprising a first data port delay register containing a first data port delay value, the audio source coupled to the audio bus; and
an audio sink comprising a second data port delay register containing a second data port delay value larger than the first data port delay value, the audio sink coupled to the audio bus;
wherein:
the master is configured to send a command to change an operation at a specific time;
the audio source delays changing the operation based on the first data port delay value relative to the specific time; and
the audio sink delays changing the operation based on the second data port delay value relative to the specific time.

25. The audio system of claim 24, wherein the audio bus comprises a SOUNDWIRE version 1.1, released August 2016 bus.

26. The audio system of claim 24, wherein the command to change the operation comprises a command to activate an audio stream.
